(19) United States
(12) Patent Application Publication
(10) Pub. No.: US 2004/0069294 A1
(43) Pub. Date: Apr. 15, 2004

(54) Barbeque grill and stand

(75) Inventor: Martin C. Bossler, Spring Grove, IL (US)

Correspondence Address: GREER, BURNS & CRAIN, 300 S WACKER DR, 25TH FLOOR, CHICAGO, IL, 60606, US

(73) Assignee: Uniflame Corporation

(21) Appl. No.: 10/268,554

(22) Filed: Oct. 10, 2002

(51) Int. Cl. A47J 37/00; F24C 3/00

(52) U.S. Cl. 126/41 R; 126/39 R; 126/276

(57) ABSTRACT

A stand for storing an LP gas tank and for supporting a barbeque grill having a bowl includes a leg assembly having a plurality of legs and a tank platform that is in registry with a positioning ring for receiving the LP gas tank. A body has a base attached to the leg assembly and a top opposite the base. The body is configured for substantially surrounding the LP gas tank. The positioning ring is formed by a reinforced edge at the base and is configured for engaging the LP tank. A bowl support has a top surface, an outer rim, a depending lip and a plurality of ridges. Each of the ridges runs from the outer rim to the depending lip, the outer rim being configured to engage the top of the body. The top surface also has a bowl cavity configured for receiving the bowl.

### BACKGROUND OF THE INVENTION

This invention relates to stands for barbeque grills. Specifically, it relates to a pedestal-style stand for an oval barbeque grill with improved support features and LP tank storage.

Barbeque grills are available in a variety of shapes and sizes. Small grills are supported upon a tabletop, or other substrate, and larger units generally have an integrated cart, stand, legs or support assembly supporting them at a height convenient for cooking food. Many designs are known to support square, rectangular and round grills. Recently, oval-shaped grills have become popular. Stands have been provided with three or four legs, or with carts of various styles.

When designing a stand or cart for a gas grill, it is also desirable to provide a place for storage of the gas cylinder. Preferably, the storage area is located where the gas cylinder is out of sight, or is configured so that the cylinder is in an aesthetically pleasing location. Where the cylinder is kept in an enclosed space for aesthetic reasons, the area around the cylinder should be well ventilated to prevent gas build-up.

The design of a grill support in which the gas tank can be stored is a challenge to design. The standard gas tank holds 20 pounds of gas and is more than 12 inches wide. To provide adequate air circulation, there must be clearance around the tank for air movement. Manufacture of a hollow body of that size tends to either be very heavy or very unstable. Thick walls become heavy quickly with increasing body diameter, resulting in high shipping costs and difficulty for the user in assembling or transporting the grill. Thinner, lighter weight body walls tend to flex and wobble if the grill is bumped or moved, leading to instability. Further, it is desirable to provide the user with table or shelf space upon which to place utensils or foodstuffs for use during cooking.

Further, in some applications, the shape of the barbeque grill leads to design difficulties due to uneven distribution of weight due to shape. In the case of oval-shaped barbeque grills, the center of the grill, the diameter of the grill is at its maximum and tapers in two dimensions as one moves outward along the major axis. The portions of the grill at the ends of the major axis are not only narrower along the minor axis, but typically less deep as well. In contrast, a round grill has its weight distributed evenly radially about the center. Rectangular or square grills usually have their weight distributed linearly. However, the weight of an oval grill is not equally distributed in either direction.

### SUMMARY OF THE INVENTION

These and other design and production considerations are met or exceeded by the present invention which features a pedestal-type stand for a barbeque grill that provides a hollow storage space for the LP tank, yet is stable.

More specifically, the present invention provides a stand for storing an LP gas tank and for supporting a barbeque grill having a bowl. The stand includes a leg assembly having a plurality of legs and a tank platform that is in registry with a positioning ring to receive the LP gas tank. A body has a base attached to the leg assembly and a top opposite the base. The body is configured for substantially surrounding the LP gas tank and defines an LP tank cavity. The positioning ring is formed by a reinforced edge at the base and is configured for engaging the LP tank. A bowl support has a top surface, an outer rim, a depending lip and a plurality of ridges. Each of the ridges runs from the outer rim to the depending lip, the outer rim being configured to engage the top of the body. The top surface also has a bowl cavity configured to receive the bowl.

Another embodiment of the invention includes a combined oval barbeque grill and pedestal stand. The stand is used with an oval barbeque grill that includes a bowl, a lid, and a gas burner. The LP gas tank is in fluid communication with the burner. The bowl rests in a bowl cavity in the bowl support.

The present stand is stronger and more stable than others having a storage space for the LP tank in the body of the cart. Hidden storage for the tank makes the grill and its stand look less cluttered than having the tank resting on the substrate beside the grill. Inclusion of the tank on the cart also makes it easier to move the grill and tank as a unit without having to disconnect and reconnect the gas supply.

A number of features contribute specifically to the stability of the structure, reducing its ability to flex or wobble. Folds or creases in the metal provide rigidity in particular directions that discourages the metal from bending or flexing in specific. This top surface also adds support to the structure by distributing the weight of an oval grill over a wide area.

### DETAILED DESCRIPTION OF THE DRAWINGS

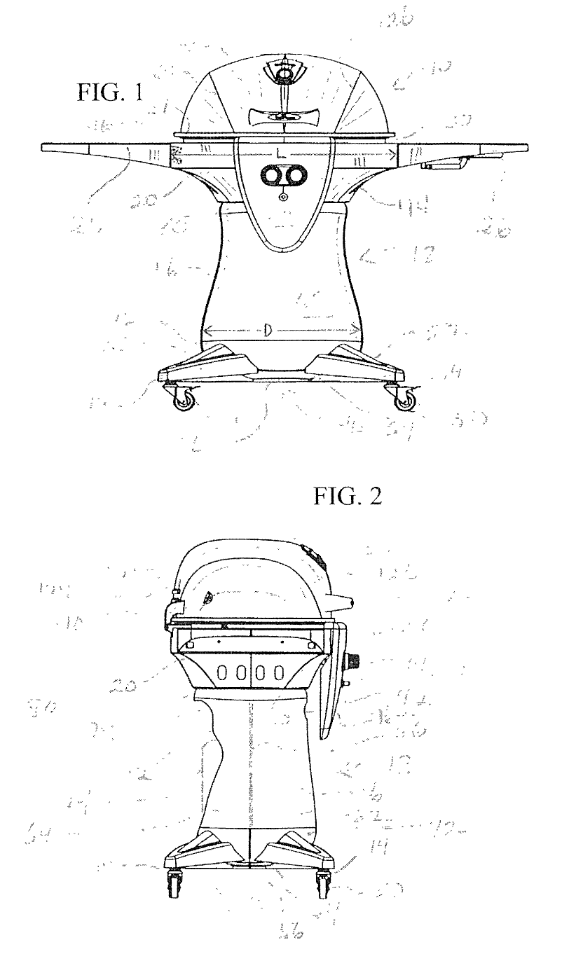

FIG. 1 is a front view of one embodiment of the present oval barbeque grill;

FIG. 2 is a side view of the grill and stand of FIG. 1;

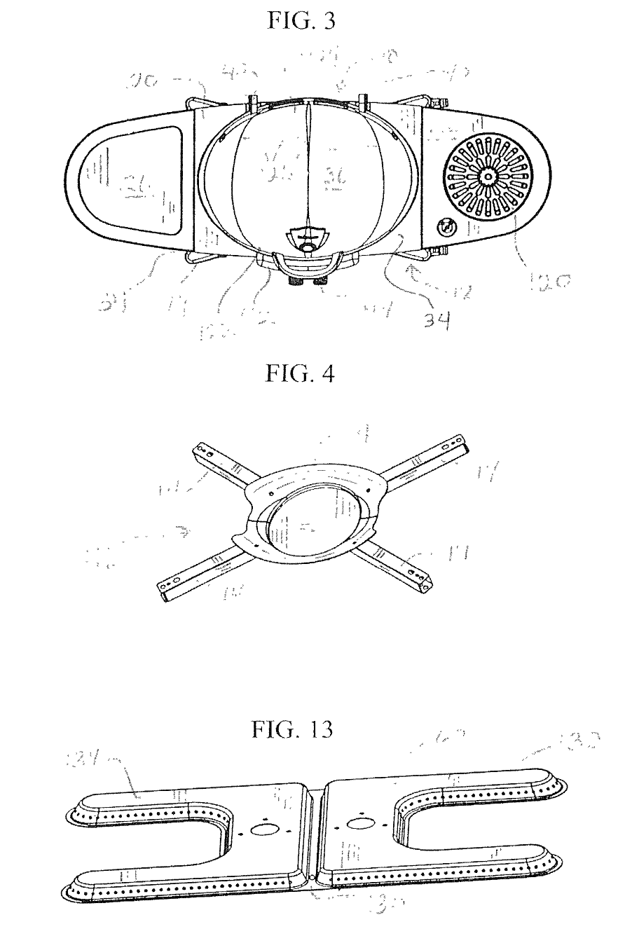

FIG. 3 is a top view of the grill and stand of FIG. 1;

FIG. 4 is a top perspective view of the leg assembly;

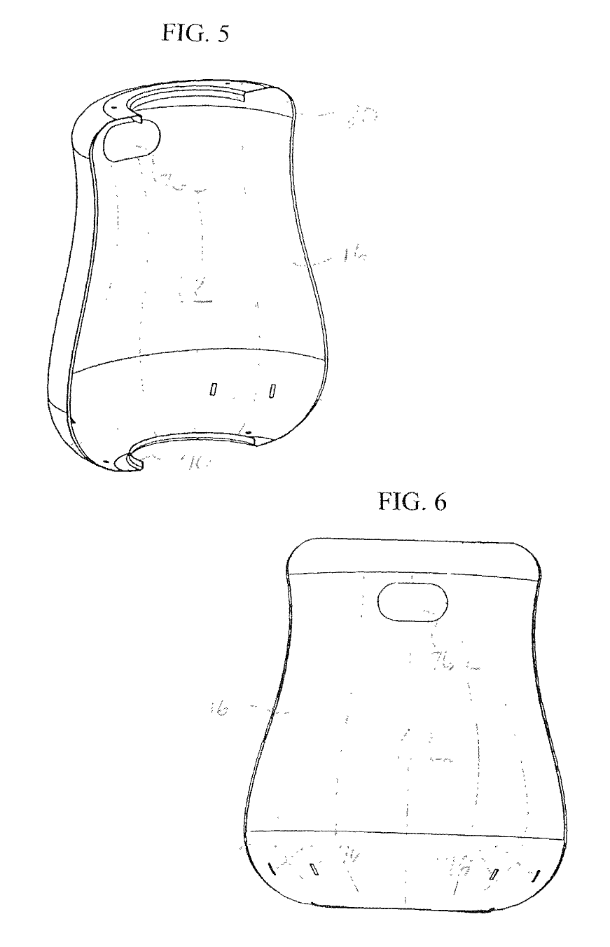

FIG. 5 is a rear perspective view of the front body;

FIG. 6 is a front elevation view of the front body;

FIG. 7 is a rear perspective view of the back body;

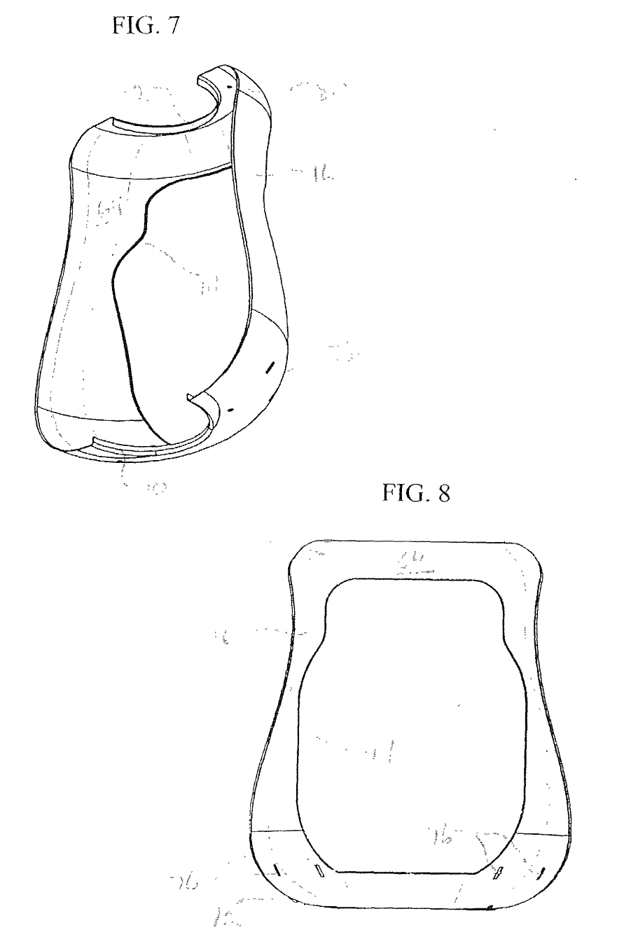

FIG. 8 is a rear elevation of the back body;

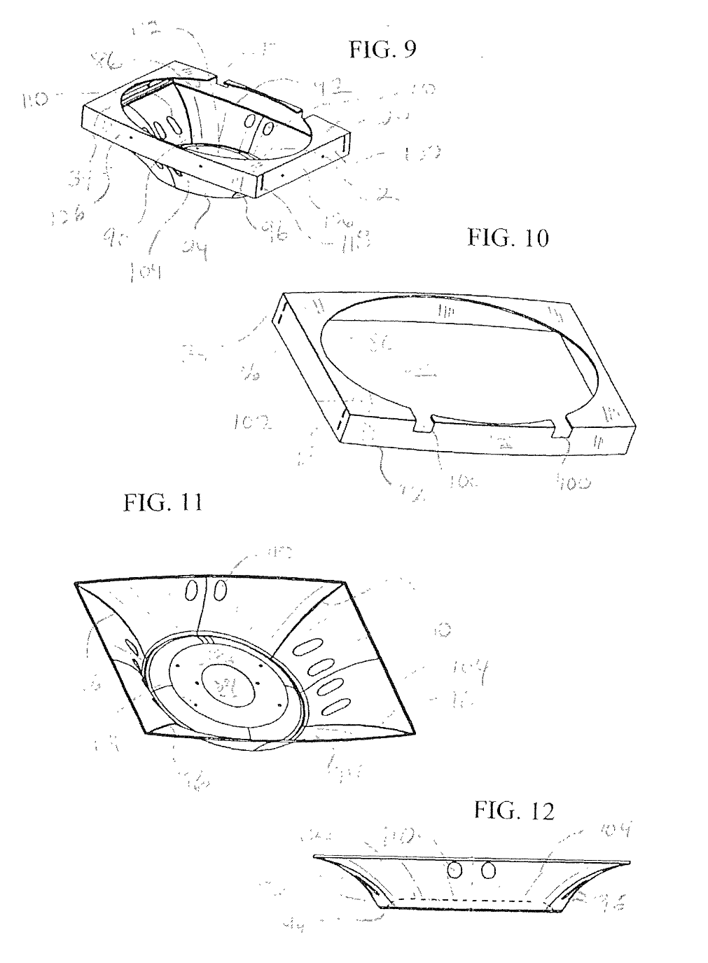

FIG. 9 is a rear perspective view of the bowl support;

FIG. 10 is a front perspective view of the upper bowl support;

FIG. 11 is a front perspective of the lower bowl support;

FIG. 12 is a side elevation of the bowl support with the body cap shown hidden; and

FIG. 13 is a top perspective view of the burner.

### DETAILED DESCRIPTION OF THE INVENTION

The present invention relates to a barbeque grill, generally designated 10, and a stand, generally designated 12, for use with the grill. Although a specific oval grill 10 is discussed and claimed, it is contemplated that the stand 12 can be used with any suitable grill, including those that are round, square or rectangular. Any directional references used herein are intended to be interpreted as if the stand 12 is oriented as shown in FIG. 1.

Referring to FIGS. 1 and 2, the stand 12 has a plurality of legs 14, a body 16 and a bowl support 20. The body 16 serves as a pedestal for elevating the bowl support 20 and the grill 10 above the legs 14, and it also defines a storage cavity 22 for a standard 20-pound LP gas tank 24. Optional side shelves 26 attach to the bowl support 20 if additional shelf space is desired. The legs 14 extend generally radially from the body 16. In the preferred embodiment, the legs 14 are generally perpendicular to the body 16, however the angular orientation of the legs may vary to suit the application.

A bowl 30 of the grill 10 is retained in an opening 32 on a top surface 34 of the bowl support 20. A lid 36 rests atop the bowl 30 and is attached to the bowl by one or more hinges 40. A control panel 42 attached to one side of the bowl support 20 provides the mounting point for one or more knobs 44 that control the temperature inside the grill 10 during cooking.

It will be seen that the bowl support 20 has length ‘L’ which is greater than a widest point of diameter ‘D’ of the body 16. The body 16 is provided in a generally tubular configuration with a radial dimension large enough to accommodate the LP gas tank 24 and provide sufficient clearance and ventilation space as is known in the art.

Referring now to FIG. 4, the legs 14 are connected to each other in the leg assembly, generally designated 46. Preferably, the leg assembly 46 has three or four of the legs 14. One embodiment has four of the legs 14 placed in an “X” shaped arrangement for strength and stability. Use of three of the legs 14 is another preferred embodiment, as three legs always define a plane, and do not wobble regardless of the contour of the substrate upon which they rest. Any shape or configuration of the legs 14 is suitable that is not prone to tipping, a condition that could pose a safety hazard if the grill 10 is hot in preparation for cooking. Pipe or bar stock makes suitable legs 14 as long as the wall thickness is sufficient for bearing the weight of the stand and grill without flexing. Referring to FIG. 1, optional wheels 50 or casters are mounted to the legs 14 for ease in moving the grill 10 and the stand 12. Decorative covers 52 are also optionally added to the legs 14 to make them more visually appealing.

Referring again to FIGS. 2 and 4, the leg assembly 46 also includes a tank platform 54 mounted to the legs 14. The platform 54 provides a flat surface 56 on which the LP tank 24 rests, making it more stable, particularly when the grill 10 and stand 12 are being moved. Weight of the grill 10 and the stand 12 is also distributed more evenly over the legs 14 by the platform 54. In the preferred embodiment, the tank platform 54 is disposed on the leg assembly 46 so that the tank 24 is generally coaxial with the bowl 30.

Preferably, the platform 54 includes a concave outer wall 57 which complements a lower end of the body 16. In the embodiment shown, the flat surface 56 is recessed or inset for more positively receiving and locating the tank 24. The inset flat surface 56 provides positive feedback to the user because the tank 24 drops slightly into the inset 56, when it is correctly positioned. While the standard 20 lb. size is contemplated for the tank 24, the tank platform 54, the flat surface 56 and the body 16 may vary in configuration to accommodate other tank sizes. Gas grills are usually heated using the standard 20-pound LP tank 24, such as those produced by Blue Rhino Corporation of Atlanta, Ga.

Referring to FIGS. 2 and 5-8, the body 16 is suitably constructed from one or more parts, preferably of two or more sections. Preferably there is a front body 62 and a back body 64. When it is formed from multiple pieces, the body 16 is simpler and less expensive to manufacture. Preferably, the front body 62 is welded to the back body 64 and, seams 66 (FIG. 2) extending down the sides of the body 16 are rolled. Rolling of the side seams 66 adds strength to the body 16 so that it flexes less under the weight of the grill 10. Rolling of the seams 66 also conceals the unfinished edges, allowing the body 16 to be made of lighter weight materials while still providing a rigid seam down each side of the body 16. Although a preferred embodiment discussed herein includes the front body 62 and the back body 64, it is also contemplated that the body 16 could be unitary.

A positioning ring 70, shown in FIGS. 5 and 7, is formed by a reinforced edge at a base 72 of the body 16. In one embodiment, the reinforced edge is rolled to provide strength as well as a finished edge around the base 72 of the body 16. Any method of reinforcing the edge is suitable, including rolling the edges, attaching reinforcing materials and the like. The positioning ring 70 is configured for receiving the tank 24 (FIG. 2) inside the body 16 and holding it in a stable fashion. Preferably, the positioning ring 70 is in registry with the inset area 56 of the platform 54 so that the tank 24 slides through the positioning ring 70 and into the inset area 56 for positive location. While the base 72 is secured to the concave wall 57 of the tank platform 54, the body 16 is attached to the leg assembly 46 by any manner suitable for the materials being used, such by fastening, welding and the like.

Referring to FIGS. 2 and 5-8, the body 16 is shaped and configured to store the LP tank 24 within the cavity 22. Any suitable mechanism is provided for access of the tank 24 to the cavity 22. In one embodiment, an opening 74 in the body 16 provides access for ingress and egress of the tank 24 (FIG. 2) to the cavity 22, preferably through the back body 64 so as to be less conspicuous. If the opening 74 is excessively large, the body 16 could be weakened, so the opening 74 is preferably no larger than necessary for access to the tank 24. Use of a door (not shown) or other covering for the body opening 74 is contemplated. Ventilation of the tank cavity 22 is maintained by leaving the entry open or by providing numerous vents 76 in the door, the body 16 or both to prevent build up of fuel gas in the body, such as from small amounts of gas that may be released when fittings are connected or disconnected. Optionally, a second vent opening 76a in the body 16 is provided for connection of the fuel line (not shown) from the LP tank 24 to the control panel 42.

Any shape is useful for the body 16 that distributes the weight of the grill 10 over the legs 14 and provides space for the tank cavity 22. One embodiment of the body 16 is generally the shape of a barrel. This embodiment is approximately cylindrical, with the positioning ring 70 having a diameter large enough to receive the tank 24. The body 16 then widens to accommodate the widest portion of the tank 24. Above the tank 24, the body 16 narrows again to a top 80 of the body 16, opposite the body base 72. Other shapes are useful for the body 16, including those that utilize a combination of square and circular cross-sections.

At the top 80 of the body 16 is a collar 82 made from at least one reinforced edge that surrounds a drip opening 84. The drip opening 84 allows cooking grease to drain from the bottom of the grill 10. The use of a pan or cup (not shown) mounted to a gas grill to collect grease, juices and other cooking waste is well known in the art, any of which are optionally utilized here. Preferably, the drip cup is mounted to the top 80 of the body, inside the tank cavity 22, by any method known in the art. In this position, the drip cup is normally hidden from view, yet is easily accessible when the contents are to be emptied.

The collar 82 is preferably round so that the edge is continuous, but any shape is suitable. Reinforcing of the collar 82 is done by rolling the edge, by welding or fastening a reinforcing material to the edge, or by any method of adding rigidity to the collar 82 so that it holds its shape without buckling. The collar 82 of a preferred embodiment is a rolled edge. Strength and stability in the vicinity of the drip opening 84 is improved when the opening is small relative to the size of the grill 10 that is intended to be supported by the stand 12. Any size is suitable for the collar 82, but it is preferably small enough to be covered by the drip cup.

Referring to FIGS. 9-11, the bowl support 20 is mounted to the top 80 of the body 16. The bowl support 20 is configured to accommodate a portion of the grill bowl 30 within it and to aid in distributing the weight of the grill 10 over the body 16 and eventually to the leg assembly 46. The bowl support 20 has an edge 86 that supports the grill bowl 30 and defines a bowl cavity 90 for holding a portion of the bowl, an outer rim 92, a depending lip 94 and a plurality of ridges 96 extending from the outer rim to the depending lip. In addition to the bowl shape, grooves 100, or openings, other shapes are optionally cut into the edge to allow connection of fuel lines or controls to the grill bowl, attachment of the control panel, and the like. Preferably the bowl support 20 is approximately funnel-shaped, being wider and flatter near the outer rim 92 and becoming deep and narrow at the lip 94. The funnel shape of the bowl support 20 is particularly important when the grill 10 has an oval shape and the deepest portion of the grill is above the lip 94.

Although the use of a one-piece bowl support 20 is contemplated, preferably it is constructed from two or more pieces, such as an upper bowl support 102 (FIG. 10) and a lower bowl support 104 (FIG. 11). The upper bowl support 102 and the lower bowl support 104 are preferably welded together, but are suitably joined by other methods. One or more optional sides 106 depend from the top surface 34 to add depth and strength to the bowl support 20.

The outer rim 92 is defined as the edge adjacent to the lower bowl support 104. If none of the sides 106 are present, the outer rim 92 is the edge of the top surface 34 of the bowl support 20. However, when the sides 106 depend from the top surface 34, the outer rim 92 is located at the edge formed by a lower edge of the side, opposite an upper edge that is attached to the top surface. If the unitary bowl support 20 is used, the outer rim 92 is an edge that corresponds to the lower edge of the sides 106 or the edge of the top surface 34.

Referring now to FIGS. 9-12, the lower bowl support 104 has a plurality of the ridges 96 from the outer rim 92 to the depending lip 94. An optimum number of the ridges 96 is from 2 to about 8. Where the outer rim 92 is rectangular as shown, there are preferably four of the ridges 96 and each of the ridges preferably runs in a generally vertical plane, approximately defined by diagonal corners of the outer rim 92, along the surface of the bowl support 20.

The bowl support 20 and the ridges 96 are shaped by any technique known in the art. One useful method is by stamping of the metal using a high pressure press. Iron or aluminum is suitably cast into the preferred shape. The ridges 96 are preferably formed with the bowl support 20 when it is made.

Preferably, the lower bowl support 104 has a concave shape from the outer rim 92 to the depending lip 94 when viewed from the exterior of the bowl support 20. Any number of vents 110 is suitably cut into the bowl support 20 surface to provide airflow to burners 60 (FIG. 13) of the grill 10, as long as the number, size and location of the vents do not significantly weaken the structure.

The depending lip 94 also defines a body cap 112 that is structured to matingly engage and be secured to the body top 80 as by welding or fastening, holding the bowl support 20 firmly in place. Where the body top 80 is rounded as shown in FIG. 1, the cap 112 is concave to conform to the convex shape of the grill bowl 30. Preferably, the interior of the cap 112 is in contact with, and provides support for the grill bowl 30 and is attached thereto. Holes 114 for screws, bolts or other fasteners are optionally provided in the cap 112 for this purpose.

Referring to FIGS. 1, 3 and 9, it is preferred that the top surface 34 and the outer rim 92 be rectangular for ease in attachment of the shelves 26 or other accessories, but any shape is suitable. As an alternative, the top surface 34 can be made large enough that the addition of work area is not advantageous. Preferably, one or more of the sides 106 of the bowl support 20 include a locator (shown hidden) to facilitate attachment of at least one of the optional side shelves 26. The side shelf 26 is suitably made of any shape or construction as is known in the art. One embodiment of the side shelf 26 is shaped similarly to an oval bisected along its minor axis. An adjoining side of the side shelf 26 is configured for attachment to the bowl support 20. A locator notch 118 on the side 106 of the bowl support 20 is aligned with the locator 116 on the shelf 26 and the shelf is fastened to the bowl support. The shelf 26 optionally includes a burner 120. Preferably, the shelf 26 gradually decreases in thickness as the distance from the bowl support 20 increases.

When the bowl support 20 is made in the disclosed shape, the resulting stand 12 is especially stable and free of wobble. The stand 12 is optionally manufactured with thinner sheet metal than could otherwise be used, thereby reducing the weight for shipping and handling by the user. If the preferred upper bowl support 102 and the lower bowl support 104 are made in separate pieces, they are advantageously stamped from sheet metal to keep the cost lower than other methods of manufacture. The preferred stand 12 is particularly useful with the oval or ellipsoid grill 10, as it evenly distributes the weight of the grill for good stability.

Referring again to FIGS. 1-3, the preferred grill 10 to be used in this stand is a gas grill generally oval or ellipsoidal in shape. It is contemplated that the stand 12 could house a charcoal grill 10, with the tank cavity 22 being used for charcoal storage. If the grill 10 is charcoal fueled, the control panel 42 is preferably omitted. The grill 10 has a front 122 closest to the consumer during use, a back 124 that is opposite the front, and a lid 36. One or more creases 126 in the lid 36 runs from the front 122 to the back 124 of the grill 10. Incorporation of the creases 126 reduces flexing of the lid 36 during rotation on the hinges 40 when it is opened and closed.

Referring to FIG. 13, the preferred grill also includes the H-shaped burner 60 for even heat distribution over an oval cooking surface (not shown). One or more fuel lines (not shown) in communication with the fuel tank 24 (FIG. 2) are fed to one or more of the burners 60, regulated through the control panel 42. When a plurality of the burners 60 is used, they need not be physically separate. In the embodiment where the grill 10 is oval, the burner 60 is an “H”-shaped burner that is split to provide separate heat control to a left side and a right side of the grill. The preferred H-shaped burner 60 has a seal 130 across two ends of the “H” and each of a first end 132 and a second end 134 of the H-shaped burner 60 are separately fueled and controlled, thus acting as two separate burners.

Referring to FIGS. 1, 2, 5, the stand 12 is assembled by a number of steps, several of which may be preformed concurrently. A plurality of the legs 14 is assembled and attached to the tank platform 54 to form the leg assembly 46. The body 16 is formed, in either a single piece or a plurality of pieces, by any suitable method, including molding, stamping, casting, carving and the like, from a suitable material. Preferably, the body front 62 and the body back 64 are stamped from a metal, such as steel. Next, the body front 62 and the body back 64 are joined by a suitable method, such as by welding, fastening, gluing, crimping, and other methods known in the art. After joining, the resulting seam 66 is preferably reinforced, such as by rolling the edges. The edge at the base 72 of the body 16 is reinforced to form the positioning ring 70. The base 72 is attached to the leg assembly 46 so that the positioning ring 70 is in registry with the tank platform 54. Any method of attaching these components is contemplated, but fastening of the base 72 to the leg assembly is preferred.

Referring to FIGS. 9-12, the bowl support 20 is formed to have the top surface 34, the outer rim 92, a plurality of the ridges 96 and the depending lip 94. Formation of the bowl support 20 is optionally completed by forming a unitary bowl support from a single piece, or by attaching two or more pieces, such as the upper bowl support 102 and the lower bowl support 104 to form the finished bowl support. Individual parts of the bowl support 20 are optionally made by stamping, molding, casting, or carving pieces from a suitable material, but are preferably stamped from a metal. The bowl support 20 is mounted to the top 80 of the body 16 by any method as will be known by an artisan. The grill bowl 30 is placed at least partially within the grill cavity 90. Although the bowl 30 is optionally secured to the stand 12, it is suitably secure in the bowl support 20 due to its weight.

While a particular embodiment of the present stand for an oval barbeque grill has been shown and described, it will be appreciated by those skilled in the art that changes and modifications may be made thereto without departing from the invention in its broader aspects and as set forth in the following claims.

What is claimed is:

1. A stand for supporting a barbeque grill having a bowl and for storing an LP gas tank comprising:
a leg assembly having a plurality of legs and a tank platform, said platform being in registry with a positioning ring for receiving the LP gas tank;
a body having a base attached to said leg assembly, a top opposite said base and defining a tank cavity configured for at least partially surrounding the LP gas tank, said positioning ring being formed by an edge of said base and being configured for engaging the LP gas tank; and
a bowl support having a top surface, an outer rim, a depending lip and a plurality of ridges, each of said ridges running from said outer rim to said depending lip, said outer rim being configured to engage said top of said body, and said top surface having a bowl cavity configured to receive the bowl.

2. The stand of claim 1 wherein said body further comprises a front body and a back body joined together and having a rolled seam.

3. The stand of claim 1 wherein said ridges are concave.

4. The stand of claim 1 wherein said tank platform further comprises an inset area and said positioning ring is in registry with said inset area.

5. The stand of claim 4 wherein said bowl support further comprises an upper bowl support and a lower bowl support, said upper bowl support includes said top surface and said lower bowl support includes said ridges, said depending lip and said rim.

6. The stand of claim 1 wherein said depending lip defines a cap configured to engage said top of said body.

7. The stand of claim 6 wherein said cap further comprises an opening configured to permit cooking waste to drain from said bowl support.

8. The stand of claim 1 further comprising at least one shelf.

9. The stand of claim 1 wherein said legs are attached to said tank platform in an “X” configuration.

10. The stand of claim 9 wherein said body further comprises one or more vents.

11. An oval barbeque grill and stand assembly with storage for an LP gas tank, said assembly comprising:
an oval grill having a bowl, a lid, and at least one gas burner, the LP gas tank being in fluid communication with said at least one burner;
a leg assembly having a plurality of legs and a tank platform, said platform being in registry with a positioning ring for receiving the LP gas tank;
a body having a base adjacent said leg assembly and a top opposite said base, said body being configured for surrounding the LP gas tank, said positioning ring being formed by a reinforced edge at said base;
a bowl support having a top surface, a rim, a plurality of sides and a plurality of ridges, each of said ridges running from said rim to one of said sides, said rim being configured for engaging said top of said body, a top surface having a bowl cavity and being mounted to said bowl support; said cavity being configured to receive said bowl; and
a bowl cavity in said top surface being configured to receive said bowl.

12. The assembly of claim 11 wherein said cover comprises one or more creases.

13. The assembly of claim 11 wherein said body further comprises one or more vents.

14. The assembly of claim 11 wherein said legs are attached to said tank platform in an “X”-shaped configuration.

15. The assembly of claim 11 wherein said lid has at least one crease perpendicular to a major axis of said oval cover.

16. The assembly of claim 12 wherein said burner is a split burner.

17. A method of making a stand for a barbeque grill comprising:
attaching a plurality of legs to a tank platform to form a leg assembly;
forming a body including a base, a top opposite said base, an edge at the base and a tank cavity configured to receive the LP gas tank;
rolling the edge to form a positioning ring;
attaching the base to the leg assembly such that said positioning ring is in registry with the tank platform;
forming a bowl support having a top surface, an outer rim, a plurality of ridges and a depending lip, each of the ridges running from the outer rim to the depending lip, the bowl support having a bowl cavity within it;
mounting the bowl support to the top of the body; and,
mounting the bowl in said grill bowl cavity.

18. The method of claim 17 wherein said forming of the bowl support comprises stamping the bowl support from metal.

19. The method of claim 18 wherein said forming of the body comprises forming a body front having an edge, forming a body back having an edge, attaching said body front to said body back and rolling the edges.
